(19) United States
(12) Patent Application Publication
(10) Pub. No.: US 2018/0309579 A1
(43) Pub. Date: Oct. 25, 2018

(54) SECURE REPRESENTATION VIA A FORMAT PRESERVING HASH FUNCTION

(71) Applicant: EntIT Software LLC, Sunnyvale, CA (US)

(72) Inventors: Luther Martin, San Jose, CA (US); Timothy Roake, Palo Alto, CA (US)

(21) Appl. No.: 15/496,285

(22) Filed: Apr. 25, 2017

(51) Int. Cl. H04L 9/32; G06Q 20/38; G06F 21/62

(52) U.S. Cl. CPC H04L 9/3242; G06F 21/6245; G06Q 20/3827; H04L 9/3226

(57) ABSTRACT

Secure representation via a format preserving hash function is disclosed. One example is a system including at least one processor and a memory storing instructions executable by the at least one processor to receive an input sequence of characters comprising characters from a first collection of Unicode code points, where the input sequence corresponds to an identifier to be represented in a secure form. A cryptographic hash function is applied to the input sequence to generate a hashed sequence of characters comprising characters from the first collection of Unicode code points. The hashed sequence is transformed to an output sequence of characters comprising characters from a proper sub-collection of the first collection of Unicode code points. The output sequence is provided to a service provider as a secure representative of the identifier.

### BACKGROUND

Sensitive information such as credit card numbers or Social Security numbers are protected via a variety of means. In some instances, cryptographic hash functions are used to generate pseudo-random data corresponding to the sensitive information.

### BRIEF DESCRIPTION OF THE DRAWINGS

Some implementations of the present disclosure are described with respect to the following figures.

FIG. 1 is a block diagram illustrating one example of a system for secure representation via a format preserving hash function.

FIG. 2 is a flow diagram illustrating one example of a method for secure representation via a format preserving hash function.

FIG. 3 is a block diagram illustrating one example of a computer readable medium for secure representation via a format preserving hash function.

### DETAILED DESCRIPTION

Sensitive data requires special handling. This includes additional protocols to safeguard and protect the confidentiality of the sensitive data. Such additional protocols require additional resources that may still be vulnerable to attack from hostile elements. Accordingly, there is a need to improve security of the sensitive data with a minimal impact on businesses that must process such sensitive data.

For example, credit cards are routinely processed by merchants at the point-of-sales (POS). However, if the merchants were to store this sensitive data, then they would need to expend considerable resources in creating and maintaining a secure data facility that stores the credit card information for its customers. Such data facilities may then be vulnerable to malicious attacks, thereby exposing the sensitive data, and causing a substantial loss of revenue, goodwill, and other business losses. Accordingly, there is a need to increase the security of the credit card information by minimizing the burden on businesses to protect such data, and also without impacting the buyer experience.

One way to achieve this desired objective is to implement encryption of sensitive credit card data in the firmware of point-of-interaction (POI) devices, immediately on swipe, insertion, tap, or manual entry. Sensitive card information may only be decrypted by the solution provider, typically a payment service. Sensitive credit card data may be removed from the POS systems and network and can therefore not be exposed, even in serious breaches. As a result, in many instances, a compromise of the point-of-sale (POS) system may be insufficient to expose customers' sensitive data. Additionally, since implementations rely on encryption on POI devices that are designed and tested for security, and decryption takes place in a highly controlled environment, the effort to demonstrate the Payment Card Industry Data Security Standard (PCI DSS) compliance for retail networks is greatly reduced.

The PCI DSS guidelines require compliance within a merchant's cardholder data environment (CDE), which includes all systems, connecting systems, and devices that store, transmit, or process cardholder data. Sensitive cardholder data (CHD) that has been encrypted with secure methods and an encryption key that is never in the merchant's possession is still in scope of DSS. Accordingly, there is a need to reduce PCI DSS compliance requirements for businesses without compromising customer experience.

In some instances, ciphertext derived from sensitive data may be stored and/or transmitted instead of the sensitive data itself. However, existing techniques that employ various encryption algorithms produce output data that is pseudo-random. Accordingly, the output may have an appearance of random bits, and may generally not resemble the format of the sensitive data itself. However, many systems are designed to process data that has a specific format. For example, systems that process credit card numbers may be designed to process a sequence of 16 digits. Likewise, systems that process social security numbers may be designed to process a sequence of 9 digits (or perhaps the last 4 digits). In some instances the format may even be a block format comprising a 3 digit sequence, followed by a 2 digit sequence, and followed by a 4 digit sequence. Consequently, when the output does not resemble the format of the input data, such systems are unable to continue processing the data. Accordingly, there is a need to apply a format preserving hash function to secure the input data and allow existing systems to process these with minimal detrimental impact to businesses and customers alike.

As described in various examples herein, secure representation via a format preserving hash function is disclosed. One example is a system including at least one processor and a memory storing instructions executable by the at least one processor to receive an input sequence of characters comprising characters from a first collection of Unicode code points, where the input sequence corresponds to an identifier to be represented in a secure form. A cryptographic hash function is applied to the input sequence to generate a hashed sequence of characters comprising characters from the first collection of Unicode code points. The hashed sequence is transformed to an output sequence of characters comprising characters from a proper sub-collection of the first collection of Unicode code points. The output sequence is provided to a service provider as a secure representative of the identifier.

As described herein, secure representation via a format preserving hash function solves a problem necessarily rooted in technology. Electronic payment systems and other online processing systems are ubiquitous. They generate and transact high volumes of data at a very high speed. Online phishing, hacking, and other malicious activities are on the rise as well. Accordingly, the techniques disclosed herein solve a technological problem of securing such online electronic data. In performing these security enhancements, the functioning of the computer is enhanced as well. The technology described herein is applied within a network of computers, as for example, an online payment system, a processor at a point-of-sales, a healthcare system, an internet of things, and so forth.

In the following detailed description, reference is made to the accompanying drawings which form a part hereof, and in which is shown by way of illustration specific examples in which the disclosure may be practiced. It is to be understood that other examples may be utilized, and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

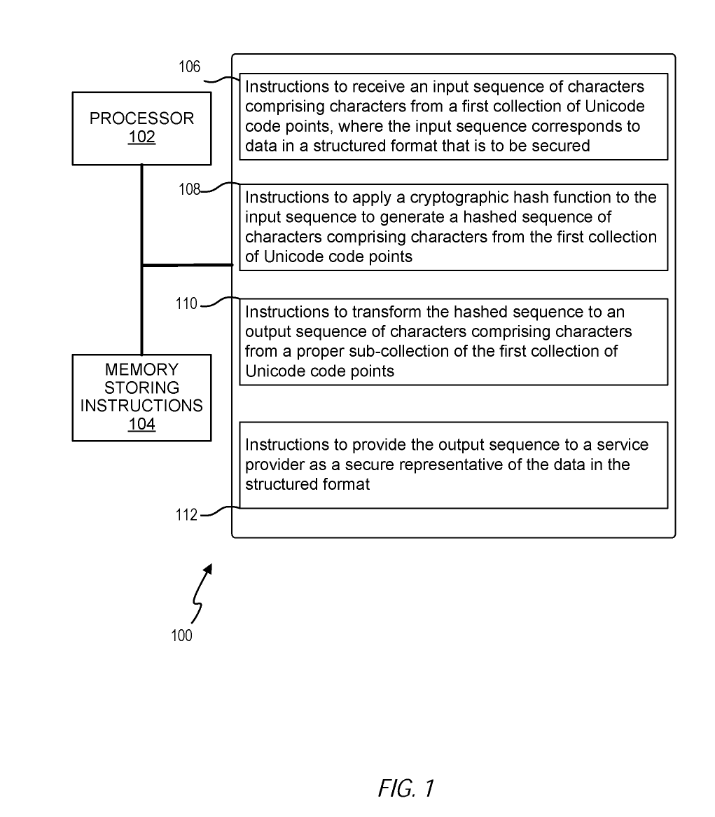

FIG. 1 is a functional block diagram illustrating one example of a system 100 for secure representation via a format preserving hash function. System 100 is shown to include a processor 102, and a memory 104 storing instructions 106-112 to perform various functions of the system.

The term “system” may be used to refer to a single computing device or multiple computing devices that communicate with each other (e.g. via a network) and operate together to provide a unified service. In some examples, the components of system 100 may communicate with one another over a network. As described herein, the network may be any wired or wireless network, including a network of cloud computing resources, and may include any number of hubs, routers, switches, cell towers, and so forth. Such a network may be, for example, part of a cellular network, part of the internet, part of an intranet, and/or any other type of network.

Memory 104 may store instructions 106 to receive an input sequence of characters comprising characters from a first collection of Unicode code points, where the input sequence corresponds to data in a structured format that is to be secured. Generally, sensitive data may be received in structured form, and may need to be secured so as to prevent malicious use of the data. For example, a 16 digit credit card number may be entered for processing at a point-of-sale. As described herein, the credit card number is to be secured so as to prevent malicious use of the credit card information. In some examples, the data in the structured format may be a 9-digit social security number, or an 8 digit birth. In some instances, the data in the structured format may be a proper name, such as a last name and a first name with a middle initial. Other types of sensitive data may include, for example, userids and passwords, an insurance policy number, an account password, a security pin, and so forth.

In some examples, the data in the structured format may be structured in blocks. For example, in a 16 digit credit card number, the first 6 digits and the last 6 digits are processed simultaneously as separate blocks, and the middle 4 digits are processed separately. Also, the last digit of a credit card number represents a checksum of the first 15 digits. As such, in some examples, the input sequence may be the first 15 digits.

Data related to birth dates may be similarly received in structured format. For example, “mm/dd/yyyy” may represent data related to birth dates. Other representations may include “dd/mm/yyyy” or “mm-dd-yy”, and so forth. Likewise, social security numbers may be represented as “xxx/xx/xxxx”. Names may also be represented in structured format as “last name, first name”. In some examples, the first character of the last name and the first name, respectively, may be expressed as an uppercase letter.

In some examples, the first collection of Unicode code points includes radix-n characters. For example, the credit card numbers, social security numbers, and so forth may be represented in base 10, i.e. n=10. In some examples, the first collection of Unicode code points includes letters of the alphabet. For example, names are generally represented by letters of the alphabet. In some examples, the first collection of Unicode code points includes alphanumeric characters. For example, passwords may be a combination of a variety of Unicode code points.

Memory 104 may store instructions 108 to apply a cryptographic hash function to the input sequence to generate a hashed sequence of characters comprising characters from the first collection of Unicode code points. A hash function, as used herein, may be any function that is used to map data of arbitrary size to data of fixed size. The outputs of a hash function are generally referred to as hash values, hash codes, or simply hashes. A cryptographic hash function is a hash function that also converts plain text to encrypted text or cipher text.

In some examples, the instructions 108 to apply the cryptographic hash function to the input sequence include instructions to preserve the structured format of the input sequence. For example, with Format-Preserving Encryption (FPE), credit card numbers and other types of data in a structured format may be protected by retaining the data format or structure. In addition, data properties, such as a Luhn checksum and field separators, may be maintained, and portions of the data may remain in the clear for processing.

For example, credit card numbers, track data and other types of data in a structured format may be protected without a need to change the data format. Merchants may preserve existing processes such as BIN routing or use of the last 4 digits of the credit card for receipt printing, while protecting sensitive digits from the browser or terminal to the payment processor. When existing encryption techniques are applied to a credit card number, the cipher text would generally correspond to a sequence of random bits. So the cipher text for a 16-digit credit card number may be any new sequence. However, when FPE is applied to the credit card number, the cipher text would correspond to another 16 digit number (or a 15 digit number if the checksum is not included).

Generally, as used herein, FPE is a mode of advanced encryption standard (AES) encryption. As an illustrative example, it may be an AES encryption as described by the NIST SP800-38G Standard and accepted by the PCI Security Standards Council (SSC) as strong encryption.

Generally, an SHA as used herein, refers to any cryptographic hash function that is designed by the United States National Security Agency and is a standard established by NIST. For example, the SHA-1 SHA produces a 160-bit (or 20 byte) hash value. Similarly, the SHA-256 SHA produces a fixed size 256-bit (or 32 byte) hash value. The output from an application of an SHA may not preserve the structured format of the input sequence. However, the output may be reduced to recreate the original format. For example, when SHA-256 is applied to a 16 digit credit card number, the output may be reduced modulo 10¹⁶ to obtain another 16 digit output. If the checksum is not hashed, then the output may be reduced modulo 10¹⁵ to obtain another 15 digit output. In this case, the 16^{th} digit may be determined as a checksum of the reduced output. In some examples, the 16^{th} digit may be introduced as a random number so as to allow systems to identify the reduced output as not being an authentic credit card number.

In some examples, the hash function is a salted hash function. A salted hash function is any hash function with a salt. The term “salt” as used herein, generally refers to an additional random data that is input to the hash function along with the input sequence. Generally, the output of the salted hash function is stored with the salt.

In some examples, the hash function is a modified FF1 algorithm based on a Feistel network. Generally, a Feistel network is utilized in generating block ciphers. An FF1 algorithm may be modified to a format preserving hashing algorithm. In some examples, the input sequence may be split into two blocks, and a Feistel network technique may be applied to each block. For example, a 16 digit credit card number may be divided into two blocks comprising 8 digits each and the Feistel network may be applied to the two blocks. Generally, such computations are performed modulo 10⁸, and may therefore be reversible. However, if the computations are now modified to be performed modulo a number m<10, then the process is irreversible due to compression of the digits. For example, the computations in the Feistel network may be performed modulo 10⁷.

Memory 104 may store instructions 110 to transform the hashed sequence to an output sequence of characters comprising characters from a proper sub-collection of the first collection of Unicode code points. Such a mapping onto a smaller subset results in a compression, which makes the secure process irreversible. Accordingly, the process becomes modified from an encryption to a hashing function. For example, the first collection of Unicode code points may include radix-n characters, and the proper sub-collection of the first collection of characters may include radix-m characters, where m is less than n. As another example, the first collection of Unicode code points may include letters of the alphabet, and the proper sub-collection of the first collection of characters may include a proper subset of the letters of the alphabet.

Memory 104 may store instructions 112 to provide the output sequence to a service provider as a secure representative of the data in the structured format. As described herein, when the merchant receives the input sequence comprising data in a structured format that is to be secured, this generally triggers costly security protocols. However, when, as described herein, the input sequence is transformed to the output sequence which is a secure representative of the input sequence, then the merchant is no longer handling sensitive data, and the costly protocols are not needed. Also, existing systems are able to process the output sequence since the format may be preserved. Also, for example, the customer experience is not altered in any way since the customer provides the input sequence, and has no knowledge of the actual transformation of the input sequence to a secured output sequence.

Generally, the components of system 100 may include programming and/or physical networks to be communicatively linked to other components of each respective system. In some instances, the components of each system may include a processor and a memory, while programming code is stored and on that memory and executable by a processor to perform designated functions.

Generally, the system components may be communicatively linked to computing devices. A computing device, as used herein, may be, for example, a web-based server, a local area network server, a cloud-based server, a notebook computer, a desktop computer, an all-in-one system, a tablet computing device, a mobile phone, an electronic book reader, or any other electronic device suitable for provisioning a computing resource to perform a unified visualization interface. The computing device may include a processor and a computer-readable storage medium.

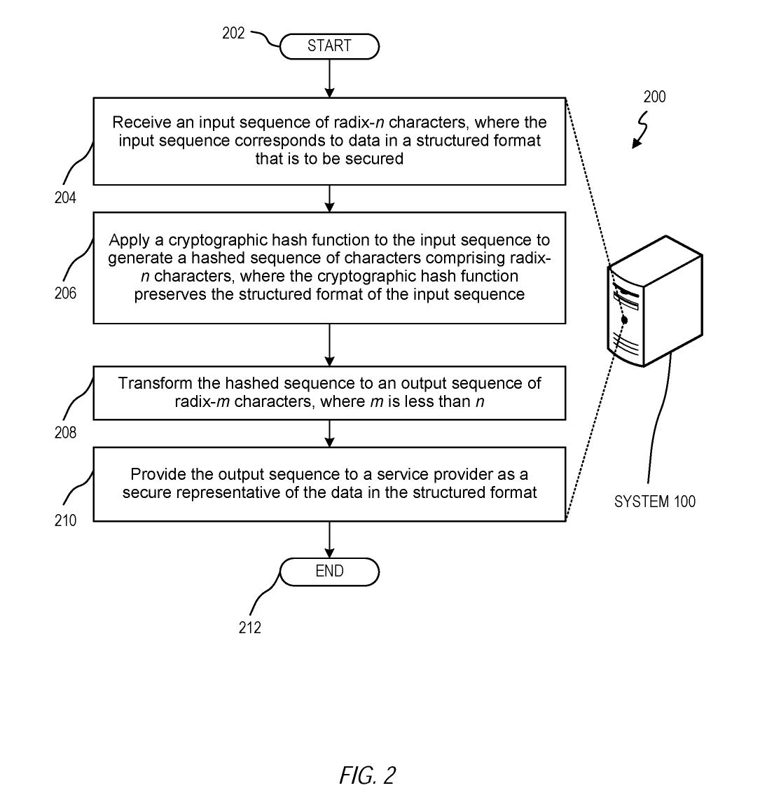

FIG. 2 is a flow diagram illustrating one example of a method for secure representation via a format preserving hash function. In some examples, such an example method may be implemented by a system such as, for example, system 100 of FIG. 1. The method 200 may begin at block 202, and continue to end at block 212.

At 204, an input sequence of radix-n characters may be received, where the input sequence corresponds to data in a structured format that is to be secured.

At 206, a cryptographic hash function may be applied to the input sequence to generate a hashed sequence of radix-n characters, where the cryptographic hash function preserves the structured format of the input sequence.

At 208, the hashed sequence may be transformed to an output sequence of radix-m characters, where m is less than n.

At 210, the output sequence may be provided to a service provider as a secure representative of the data in the structured format.

In some examples, the cryptographic hash function may be a secure hash algorithm (SHA).

In some examples, the data in the structured format may be a credit card number, a social security number, a proper name, a date of birth, an insurance policy number, an account password, or a security pin.

In some examples, the hash function may be a salted hash function.

In some examples, the hash function may be a modified FF1 algorithm based on a Feistel network.

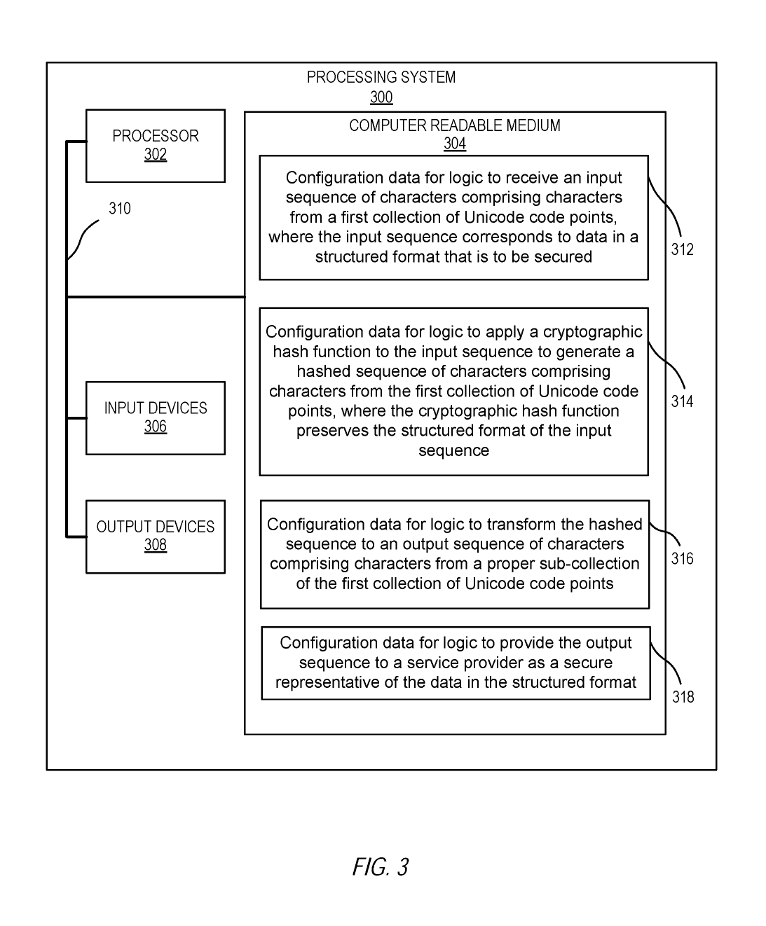

FIG. 3 is a block diagram illustrating one example of a computer readable medium for secure representation via a format preserving hash function. Processing system 300 includes a processor 302, a computer readable medium 304, input devices 306, and output devices 308. Processor 302, computer readable medium 304, input devices 306, and output devices 308 are coupled to each other through a communication link (e.g., a bus). In some examples, the non-transitory, computer readable medium 304 may store configuration data for the logic to perform the various functions of the processor 302.

Processor 302 executes instructions included in the computer readable medium 304 that stores configuration data for logic to perform the various functions. Computer readable medium 304 stores configuration data for logic 312 to receive an input sequence of characters comprising characters from a first collection of Unicode code points, where the input sequence corresponds to data in a structured format that is to be secured.

Computer readable medium 304 stores configuration data for logic 314 to apply a cryptographic hash function to the input sequence to generate a hashed sequence of characters comprising characters from the first collection of Unicode code points, where the cryptographic hash function preserves the structured format of the input sequence.

Computer readable medium 304 stores configuration data for logic 316 to transform the hashed sequence to an output sequence of characters comprising characters from a proper sub-collection of the first collection of Unicode code points.

Computer readable medium 304 stores configuration data for logic 318 to provide the output sequence to a service provider as a secure representative of the data in the structured format.

In some examples, the cryptographic hash function may be a secure hash algorithm (SHA).

In some examples, the first collection of Unicode code points may be radix-n characters, and the proper sub-collection of the first collection of characters may be radix-m characters, where m is less than n.

In some examples, the data in the structured format may be a credit card number, a social security number, a proper name, a date of birth, an insurance policy number, an account password, or a security pin.

In some examples, the hash function may be a salted hash function.

In some examples, the hash function may be a modified FF1 algorithm based on a Feistel network.

As used herein, a “computer readable medium” may be any electronic, magnetic, optical, or other physical storage apparatus to contain or store information such as executable instructions, data, and the like. For example, any computer readable storage medium described herein may be any of Random Access Memory (RAM), volatile memory, non-volatile memory, flash memory, a storage drive (e.g., a hard drive), a solid state drive, and the like, or a combination thereof. For example, the computer readable medium 304 can include one of or multiple different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage containers.

As described herein, various components of the processing system 300 are identified and refer to a combination of hardware and programming to perform a designated visualization function. As illustrated in FIG. 2, the programming may be processor executable instructions stored on tangible computer readable medium 304, and the hardware may include Processor 302 for executing those instructions. Thus, computer readable medium 304 may store program instructions that, when executed by Processor 302, implement the various components of the processing system 300.

Such computer readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

Computer readable medium 304 may be any of a number of memory components capable of storing instructions that can be executed by processor 302. Computer readable medium 304 may be non-transitory in the sense that it does not encompass a transitory signal but instead is made up of memory components to store the relevant instructions. Computer readable medium 304 may be implemented in a single device or distributed across devices. Likewise, processor 302 represents any number of processors capable of executing instructions stored by computer readable medium 304. Processor 302 may be integrated in a single device or distributed across devices. Further, computer readable medium 304 may be fully or partially integrated in the same device as processor 302 (as illustrated), or it may be separate but accessible to that device and processor 302. In some examples, computer readable medium 304 may be a machine-readable storage medium.

The general techniques described herein provide a way to store a hash or message digest of sensitive information (like a credit card number or Social Security number) instead of the sensitive information itself. One benefit of the techniques of calculating a hash, as described herein, is that it preserves the format of the input data. This makes it useful for a hash to be easily processed in many legacy environments.

Although specific examples have been illustrated and described herein, there may be a variety of alternate and/or equivalent implementations that may be substituted for the specific examples shown and described without departing from the scope of the present disclosure. This application is intended to cover any adaptations or variations of the specific examples discussed herein.

1. A system comprising:
at least one processor; and
a memory storing instructions executable by the at least one processor to:
receive an input sequence of characters comprising characters from a first collection of Unicode code points, wherein the input sequence corresponds to data in a structured format that is to be secured;
apply a cryptographic hash function to the input sequence to generate a hashed sequence of characters comprising characters from the first collection of Unicode code points;
transform the hashed sequence to an output sequence of characters comprising characters from a proper sub-collection of the first collection of Unicode code points; and
provide the output sequence to a service provider as a secure representative of the data in the structured format.

2. The system of claim 1, wherein the instructions to apply the cryptographic hash function further comprise instructions to preserve the structured format of the input sequence.

3. The system of claim 1, wherein the cryptographic hash function comprises a secure hash algorithm (SHA).

4. The system of claim 1, wherein the first collection of Unicode code points comprises radix-n characters, and the proper sub-collection of the first collection of characters comprises radix-m characters, wherein m is less than n.

5. The system of claim 1, wherein the first collection of Unicode code points comprises letters of the alphabet, and the proper sub-collection of the first collection of characters comprises a proper subset of the letters of the alphabet.

6. The system of claim 1, wherein the first collection of Unicode code points comprises alphanumeric characters.

7. The system of claim 1, wherein the data in the structured format is a credit card number, a social security number, a proper name, a date of birth, an insurance policy number, an account password, or a security pin.

8. The system of claim 1, wherein the hash function is a salted hash function.

9. The system of claim 1, wherein the hash function is a modified FF1 algorithm based on a Feistel network.

10. A method, comprising:
receiving an input sequence of radix-n characters, wherein the input sequence corresponds to data in a structured format that is to be secured;
applying a cryptographic hash function to the input sequence to generate a hashed sequence of characters comprising radix-n characters, wherein the cryptographic hash function preserves the structured format of the input sequence;
transforming the hashed sequence to an output sequence of radix-m characters, wherein m is less than n; and
providing the output sequence to a service provider as a secure representative of the data in the structured format.

11. The method of claim 10, wherein the cryptographic hash function comprises a secure hash algorithm (SHA).

12. The method of claim 10, wherein the data in the structured format is a credit card number, a social security number, a proper name, a date of birth, an insurance policy number, an account password, or a security pin.

13. The method of claim 10, wherein the hash function is a salted hash function.

14. The method of claim 10, wherein the hash function is a modified FF1 algorithm based on a Feistel network.

15. A non-transitory computer readable medium comprising executable instructions to:
receive an input sequence of characters comprising characters from a first collection of Unicode code points, wherein the input sequence corresponds to data in a structured format that is to be secured;
apply a cryptographic hash function to the input sequence to generate a hashed sequence of characters comprising characters from the first collection of Unicode code points, wherein the cryptographic hash function preserves the structured format of the input sequence;
transform the hashed sequence to an output sequence of characters comprising characters from a proper sub-collection of the first collection of Unicode code points; and
provide the output sequence to a service provider as a secure representative of the data in the structured format.

16. The computer readable medium of claim 15, wherein the cryptographic hash function comprises a secure hash algorithm (SHA).

17. The computer readable medium of claim 15, wherein the first collection of Unicode code points comprises radix-n characters, and the proper sub-collection of the first collection of characters comprises radix-m characters, wherein m is less than n.

18. The computer readable medium of claim 15, wherein the data in the structured format is a credit card number, a social security number, a proper name, a date of birth, an insurance policy number, an account password, or a security pin.

19. The computer readable medium of claim 15, wherein the hash function is a salted hash function.

20. The computer readable medium of claim 15, wherein the hash function is a modified FF1 algorithm based on a Feistel network.
